(19) United States
(12) Patent Application Publication
(10) Pub. No.: US 2007/0042703 A1
(43) Pub. Date: Feb. 22, 2007

(54) Ventilation apparatus for sliding window

(76) Inventor: Jin-Woo Lee, Seoul (KR)

Correspondence Address: CANTOR COLBURN, LLP, 55 GRIFFIN ROAD SOUTH, BLOOMFIELD, CT, 06002, US

(21) Appl. No.: 11/367,063

(22) Filed: Mar. 3, 2006

(30) Foreign Application Priority Data
Aug. 16, 2005 (KR) 10-2005-0074738
Nov. 3, 2005 (KR) 10-2005-0104988

(51) Int. Cl. E06B 7/02

(52) U.S. Cl. 454/213

(57) ABSTRACT

The present invention relates to a ventilation apparatus for a sliding window, and more particularly, to a ventilation apparatus for a sliding window, which has improved easiness of mounting/demounting, enhanced airtightness/watertightness and thermal insulation, and improved shielding against external contaminants. A ventilation apparatus for a sliding window according to the present invention comprises a main body that is installed on at least one end of a window including a window frame and a glass pane and has a plurality of ventilation holes formed therein; an indoor cover detachably coupled to an indoor side surface of the main body; an outdoor cover detachably coupled to an outdoor side surface of the main body; a glass pane-fixing rim detachably coupled to a lower end of the indoor or outdoor side surface of the main body so as to fix the glass pane; and finishing caps fitted into both side ends of the main body.

This application claims the benefit of the filing date of Korean Patent Application Nos. 10-2005-0074738 and 10-2005-0104988, filed on Aug. 16, 2005 and Nov. 3, 2005, in the Korean intellectual Property Office, the disclosure of which is incorporated herein its entirety by reference

### BACKGROUND OF THE INVENTION

1. Field of the Invention

The present invention relates to a ventilation apparatus for a sliding window, and more particularly, to a ventilation apparatus for a sliding window, which has improved easiness of mounting/demounting, enhanced airtightness/watertightness and thermal insulation, and improved shielding against external contaminants.

2. Description of the Related Art

Generally, as for methods for ventilating a room, there are a method of naturally ventilating a room by opening a window, and a method of forcibly ventilating a room by operating a forced ventilation apparatus. The former, i.e., the method of ventilating a room by opening a window, is mainly used in ordinary homes. However, the method of ventilating a room by opening a window is not desirable since it has a problem in that contaminants such as dust or various noxious insects contained in outdoor air may be introduced into the room. Accordingly, heretofore, an openable ventilation apparatus is provided at a portion of a window frame to ventilate a room as well as to maintain thermal insulation. As shown in FIGS. 1 to 3, such a conventional ventilation apparatus comprises a bar-shaped metallic body 20 that has an upper portion coupled to a window frame 2a and a lower portion into which an upper portion of a glass pane 3 is inserted with a rubber gasket 21 interposed therebetween, and is provided with an air passage 22 for allowing air to flow therethrough; an opening/shutting plate 30 provided in an inner space 23 of the metallic body 20 to be rotated by a lever 31 so as to open and shut the air passage 22; and a cover 40 coupled over an indoor air passage of the metallic body 20 and having a fly net 50 provided therein.

In such a conventional ventilation apparatus, the air passage 22 can be opened by operating the opening/shutting plate 30 to ventilate a room, and the air passage 22 can be closed by operating the opening/shutting plate 30 to block a flow of air as well as to achieve thermal insulation. In addition, since the fly net 50 is provided, it is possible to prevent a noxious insect from entering a room even though the ventilation apparatus is opened.

However, the conventional ventilation apparatus for a window has the following problems.

First, since the ventilation apparatus is generally made of metal as a whole, it has inferior performance in view of thermal insulation and prevention of dew condensation.

That is, outdoor heat or cold is easily conducted through the metallic ventilation apparatus and has an influence on indoor temperature, resulting in deterioration of thermal insulation performance. For example, there are the following problems. In summer, indoor temperature is raised due to the conducted heat through the metallic ventilation apparatus. On the contrary, in winter, indoor temperature is lowered and a dew condensation phenomenon occurs due to difference in temperature between indoor temperature and the outdoor temperature. In addition, the air passage 12 is clogged due to such a dew condensation phenomenon.

Second, the conventional ventilation apparatus suffers from difficulty in mounting and demounting the ventilation apparatus.

That is, in order to demount the conventional ventilation apparatus, the window 2 should be first separated from a sash 1 before the ventilation apparatus 10 is separated from the pane 3. Accordingly, since such a large-sized and heavy window should be first separated in order to demount the ventilation apparatus, the demounting of the ventilation apparatus becomes inevitably a difficult operation. Further, since an operation for mounting the ventilation apparatus is performed in the reverse order, the same problem arises as well.

Third, since an air filter is not provided in the conventional ventilation apparatus, there is a problem that fine dust contained in outdoor air is introduced into a room.

### SUMMARY OF THE INVENTION

Accordingly, the present invention is conceived to solve the aforementioned problems in the prior art. A primary object of the present invention is to provide a ventilation apparatus for a sliding window, which has an improved structure to secure easiness of mounting/demounting, superior airtightness/watertightness and thermal insulation, and prevention of introduction of external contaminants.

According to the present invention for achieving the object, there is provided a ventilation apparatus for a sliding window, comprising a main body that is installed on at least one end of a window including a window frame and a glass pane and has a plurality of ventilation holes formed therein; an indoor cover detachably coupled to an indoor side surface of the main body; an outdoor cover detachably coupled to an outdoor side surface of the main body; a glass pane-fixing rim detachably coupled to a lower end of the indoor or outdoor side surface of the main body so as to fix the glass pane; and finishing caps fitted into both side ends of the main body.

The ventilation apparatus preferably further comprises an air filter provided between the main body and the indoor cover to filter out contaminants contained in outdoor air introduced into a room through the ventilation holes. The main body, the outdoor cover, the indoor cover and the finishing caps are preferably made of plastic materials.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a view showing a state that a ventilation apparatus for a sliding window is installed;

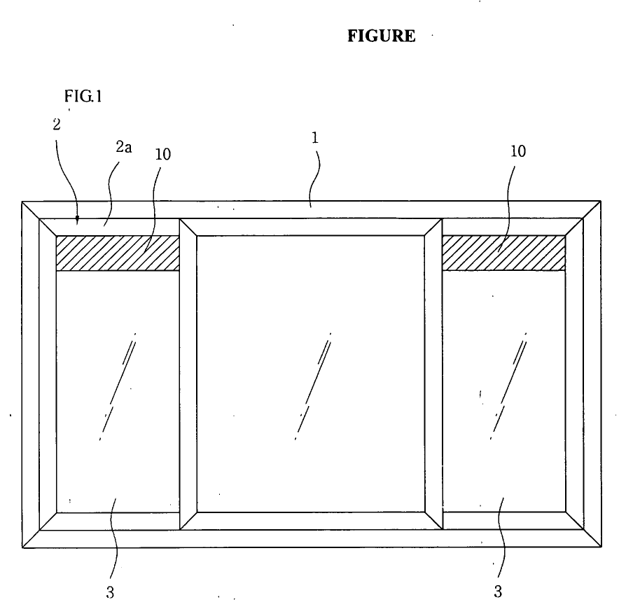

FIG. 2 is a perspective view showing a structure of a conventional ventilation apparatus for a sliding window;

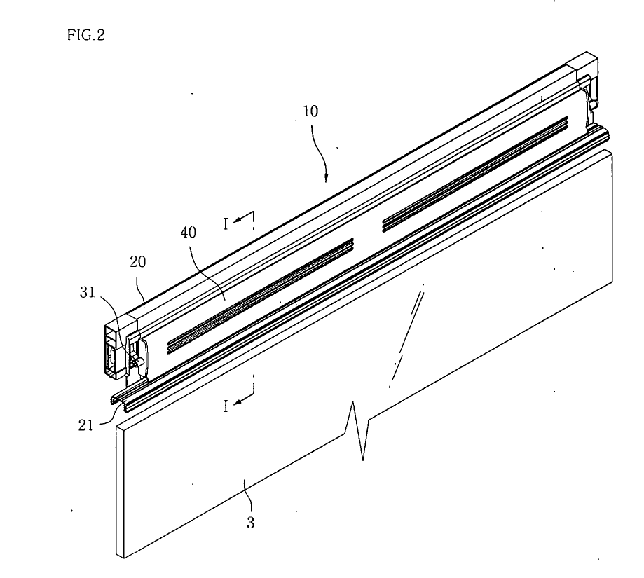

FIG. 3 is a sectional view taken along line I-I in FIG. 1;

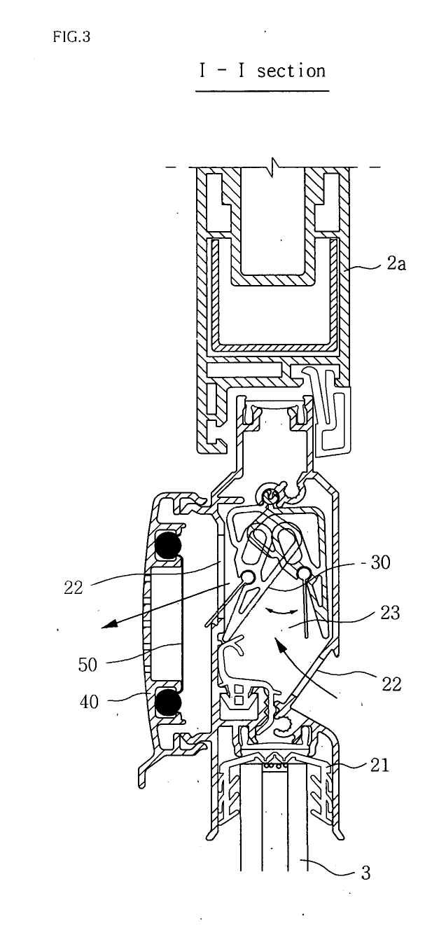

FIG. 4 is a view showing a structure of a ventilation apparatus for a sliding window according to a first embodiment of the present invention;

FIG. 5 is a longitudinal sectional view showing an assembled state of the ventilation apparatus of FIG. 4;

FIG. 6 is a view showing a state where a glass pane is being demounted;

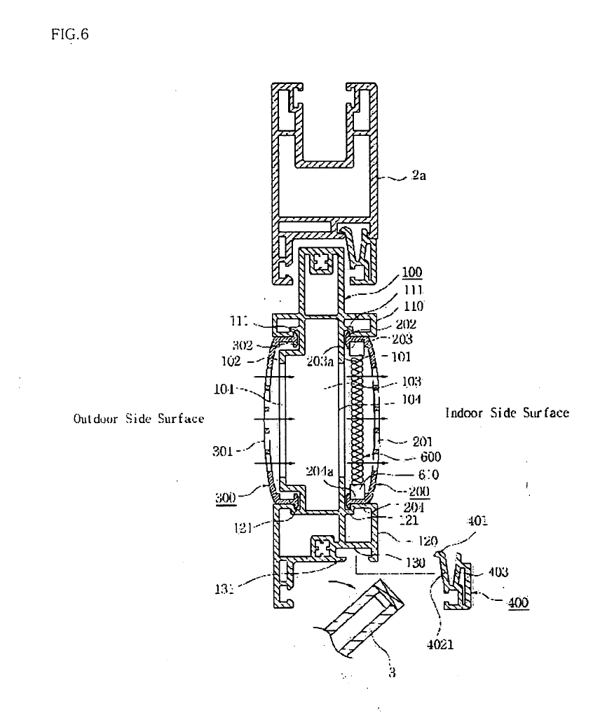

FIGS. 7 and 8 are views showing a state that the ventilation apparatus according to the first embodiment of the present invention is installed at a window;

FIG. 9 is a view showing a structure of a ventilation apparatus for a sliding window according to a second embodiment of the present invention; and

FIG. 10 is a longitudinal sectional view showing an assembled state of the ventilation apparatus of FIG. 9.

### DESCRIPTION OF THE PREFERRED EMBODIMENTS

Hereinafter, preferred embodiments of the present invention will be described in detail with reference to the accompanying drawings.

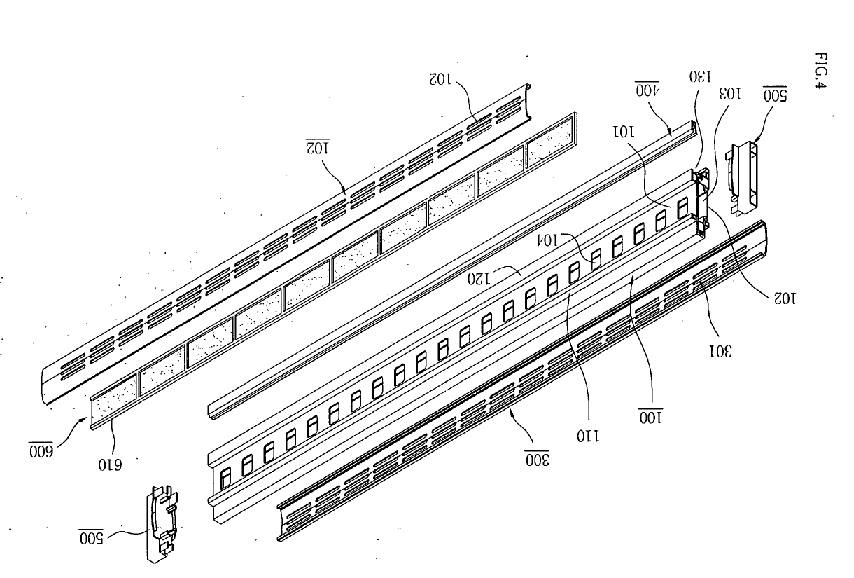

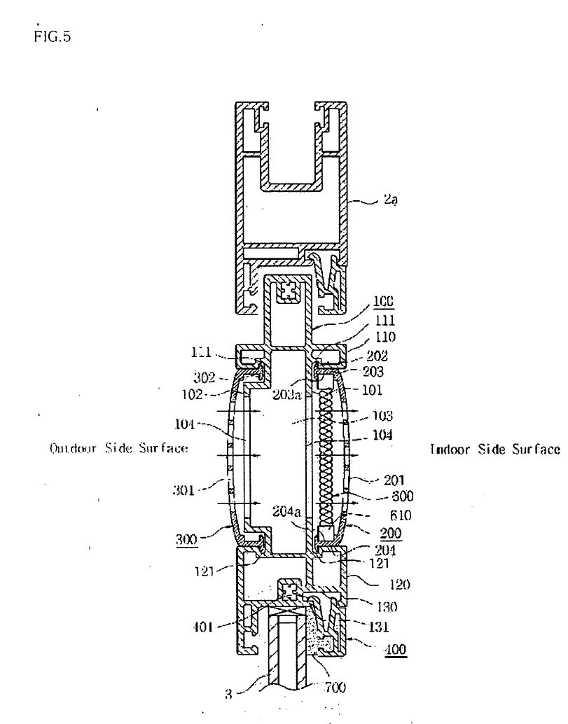

As shown in FIGS. 4 and 5, a ventilation apparatus for a sliding window according to a first embodiment of the present invention roughly comprises a main body 100, an indoor cover 200, an outdoor cover 300, a glass pane-fixing rim 400, and finishing caps 500.

Here, the ventilation apparatus can be installed on at least one of ends of a window 2 comprising a glass pane 3 and a window frame 2a. However, the embodiment of the present invention will be described in connection with an example in which the ventilation apparatus is installed on an upper end of the window 2.

The main body 100 serves as a structural skeleton of the ventilation apparatus and comprises an indoor side surface 101, an outdoor side surface 102, and a space 103 with a certain size formed between the indoor and outdoor side surfaces.

At this time, a plurality of ventilation holes 104 are formed in a longitudinal array in each of the indoor side surface 101 and the outdoor side surface 102, and an upper sill 110 and a lower sill 120 are formed at an upper portion and a lower portion of each of the indoor and outdoor side surfaces 101 and 102, respectively. The lower sill 120 formed at the indoor side surface has a mounting section 130 formed at the bottom thereof, and the glass pane-fixing rim 400 is mounted on the mounting section.

Here, both lower ends of the mounting section 130 are bent oppositely in a fore and aft direction to form engaging steps 131, so that corresponding engaging steps 401 formed at an upper end of the glass pane-fixing rim 400 can be engaged with the engaging steps 131 in a hook manner.

The indoor cover 200 and the outdoor cover 300 are formed with a plurality of slits 201 and 301 through which air passes. The indoor cover 200 is detachably coupled to the indoor side surface of the main body 100, and the outdoor cover 300 is detachably coupled to the outdoor side surface of the main body 100.

Engaging protrusions 202 and 302 are formed integrally with upper and lower ends of the indoor cover 200 and the outdoor cover 300 by being bent toward the upper sill 110 and the lower sill 120 of the main body 110, so that they can be caught by recesses 111 and 121 formed in the upper sill 110 and the lower sill 120, respectively. At this time, the indoor cover 200 and the outdoor cover 300 can be elastically deformed so that the engaging protrusions 202 and 302 can be easily fitted into or escape from the recesses 111 and 121. Further, an air filter 600 is provided between the main body 100 and the indoor cover 200 to filter out contaminants contained in outdoor air introduced through the ventilation holes 104 of the main body 100. Here, the air filter 600 has appropriate meshes so that noxious insects and fine dust particles can be filtered out by the air filter.

It is possible to install the air filter 600 in the indoor cover 200. To this end, coupling grooves 203a and 204a are formed in inside an upper flange 203 and a lower flange 204 of the indoor cover 200, respectively, and a filter frame 610 is provided at an edge of the air filter 610 to be fitted into the coupling grooves 203a and 204a. Of course, the air filter 600 may be provided within the outdoor cover 300 to have the same installation structure as in the outdoor cover 200 described above.

It is preferred that an antibiotic filter, for example an antibiotic filter employing silver nano technology, be used as the air filter 600. The antibiotic principle of silver nano technology is that, when oxygen molecules come into contact with the surface of silver, oxygen molecules are adsorbed as oxygen atoms (atomic oxygen), so that this oxygen atoms can oxidize and sterilize bacteria, virus and the like.

The glass pane-fixing rim 400 is secured on an indoor-side end surface of the glass pane 3 to prevent the glass pane from being separated from the main body 100. On the contrary, once the glass pane-fixing rim 400 is separated from the body 100, the glass pane 3 can be easily separated from the body 100. Thus, the glass pane-fixing rim 400 serves to facilitate mounting and demounting of the glass window 3.

Here, the glass pane-fixing rim 400 has a sectional shape such that a distance between two upper ribs 402 and 403 increases gradually upward, thereby allowing the two ribs 402 and 403 to be puckered up. The corresponding engaging steps 401 are formed at upper ends of the two ribs 402 and 403 so as to be usefully used when the corresponding engaging steps 401 of the glass pane-fixing rim 400 are engaged with the engaging steps 131 of the lower sill 120.

Further, a gasket 700 is interposed between the glass pane-fixing rim 400 and the glass pane 3 to seal a gap formed between them, thereby maintaining airtightness and watertightness and absorbing a shock applied to the glass pane.

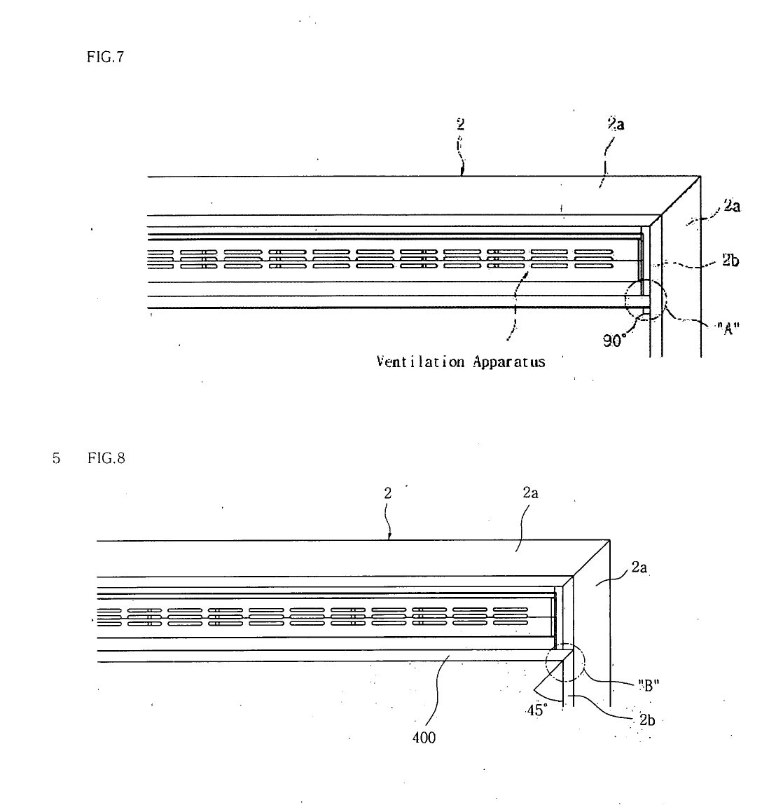

Both ends of the glass pane-fixing rim 400 on the side of the main body 100 are in face-to-face contact with a glass pane-fixing rim 2b on the side of the window frame 2a. In the first embodiment of the present invention, as shown in FIGS. 7 and 8, the face-to-face contact angle is in a range of acute angles. Preferably, both the glass pane-fixing rims 400 and 2b are in face-to-face contact with each other at an angle of 45° (portion “B” in FIG. 8) to increase a contact area, thereby establishing a stable face-to-face contact.

It will also be apparent that, as shown in FIG. 7, the glass pane-fixing rim 400 on the side of the main body 100 may be in face-to-face contact with the glass pane-fixing rim 2b on the side of the window frame 2a at a right angle (90°) (portion “A” in FIG. 7).

The finishing caps 500 are fitted into both ends of the main body 100 and serve to prevent the indoor cover 200 and the outdoor cover 300 from being separated from the main body 100.

Meanwhile, in the first embodiment of the present invention, it is preferred that the main body 100, the indoor cover 200, the outdoor cover 300 and the finishing caps 500 of the ventilation apparatus be made of plastic materials. Since it is well known that plastic materials is superior to metal materials in view of thermal insulation and prevention of dew condensation, the plastic materials can be usefully applied to a window to be installed at an interface between the outside and a room.

Hereinafter, the process of ventilating a room using the ventilation apparatus according to the first embodiment of the present invention described above will be described.

First, outdoor air is introduced into the ventilation apparatus through the slits 301 of the outdoor cover 300. Then, the air sequentially passes through the ventilation holes 104 of the indoor side surface 101 and the outdoor side surface 102 of the main body 100 and subsequently through the slits 201 of the indoor cover 200 into the room.

At this time, since the air filter 600 is provided in the indoor cover 200, various contaminants contained in the outdoor air are filtered out when the outdoor air to be introduced into the room passes through the air filter 600. Thus, only the filtered air is introduced into the room.

At the same time, indoor air flows and is exhausted from the room to the outside in the reverse order of the aforementioned process. As the introduction of the outdoor air and the exhaust of the indoor air are repeatedly performed, the ventilation of the room is achieved.

Further, since the main body 100, the indoor cover 200, the outdoor cover 300 and the finishing caps 500 of the ventilation apparatus according to the first embodiment of the present invention are made of plastic materials as a whole, it is possible to prevent external heat from being conducted through the ventilation apparatus into the room even though temperature at the outside is high. Accordingly, it is possible to prevent temperature in the room from increasing due to conduction heat through the ventilation apparatus.

Moreover, since the main body 100, the indoor cover 200, the outdoor cover 300 and the finishing caps 500 of the ventilation apparatus according to the first embodiment of the present invention are made of plastic materials as a whole, it is possible to beforehand prevent a dew condensation phenomenon from occurring on the ventilation apparatus even though there is a large difference in temperature between the room and the outside.

Meanwhile, in order to clean the ventilation apparatus according to the first embodiment of the present invention or exchange it with new one due to breakage or the like, a user should separate the ventilation apparatus from the window frame 2a. Of course, if the user wants to clean only the air filter 600, the user separates the indoor cover 200 from the main body 100 and then demounts the air filter 600 provided in the indoor cover 200.

However, if the main body 100 itself is required to be cleaned, the user should separate the entire ventilation apparatus from the window 2 as described above. To this end, the gasket 700 disposed between the glass pane-fixing rim 400 and the glass pane 3 is cut to separate the glass pane from the glass pane-fixing rim. Then, the glass pane-fixing rim 400 is compressed and deformed toward the glass pane 3 to release engagement between the corresponding engaging steps 401 of the glass pane-fixing rim and the engaging steps 131 of the lower sill 120 so that the glass pane-fixing rim can be separated from the glass pane 3. The glass pane 3 is then pulled toward the indoor side, so that the glass pane 3 can be separated from the main body 100.

Thereafter, the ventilation apparatus is separated from the window frame 2a. Consequently, the process of demounting the ventilation apparatus is completed.

Accordingly, with the ventilation apparatus according to the first embodiment of the present invention, it is possible to eliminate inconvenience produced in a conventional ventilation apparatus, which results from demounting of an entire window required in a case where the conventional ventilation apparatus is intended to be separated from a window frame.

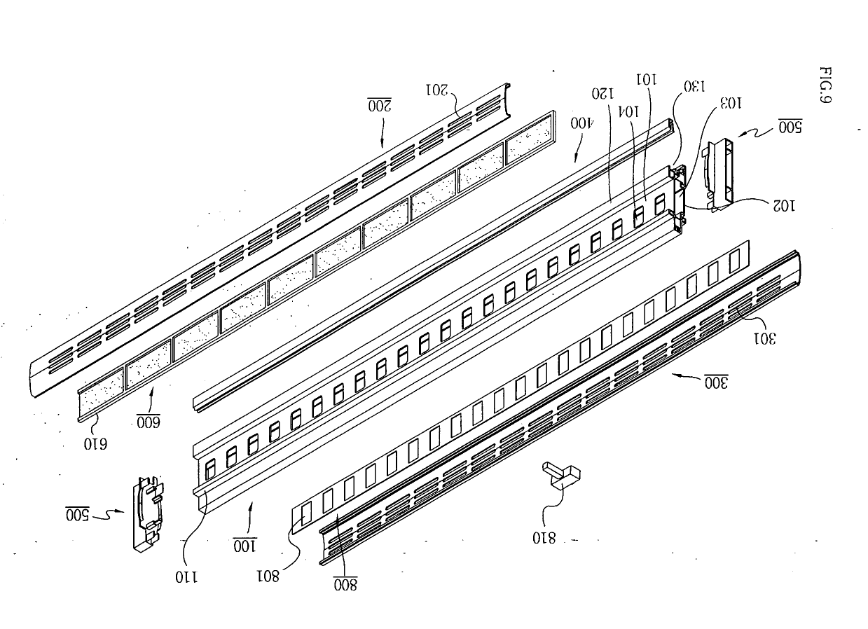

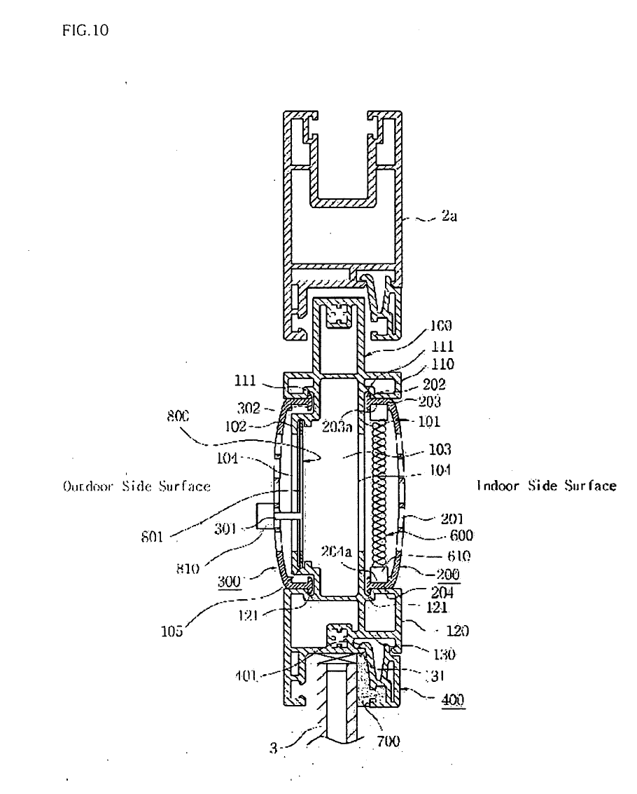

FIGS. 9 and 10 show a ventilation apparatus for a sliding window according to a second embodiment of the present invention. The detailed structure of the ventilation apparatus will be described below.

In the ventilation apparatus according to the second embodiment of the present invention, ventilation holes 104 of a main body 100 is selectively opened or closed, so that outdoor air can be prevented from being introduced into a room if ventilation is not required in the room.

The structure of the ventilation apparatus according to the second embodiment of the present invention will be described in greater detail below.

First, the ventilation apparatus according to the second embodiment of the present invention further comprises a ventilation holes-opening/closing plate 800 and an operating lever 810, as compared with the ventilation apparatus according to the first embodiment of the present invention.

Here, the ventilation hole-opening/closing plate 800 is formed as a thin plate with a plurality of communication holes 801 formed therein corresponding to the ventilation holes 104 and is provided in the main body 100. At this time, guide grooves 105 are formed at upper and lower portions of an outdoor side surface of the main body 100, so that the ventilation hole-opening/closing plate 800 can be moved slidably in a longitudinal direction of the main body 100, and upper and lower ends of the ventilation hole-opening/closing plate 800 are received in the guide grooves 105, respectively.

That is, while the ventilation hole-opening/closing plate 800 is moved slidably in a lateral direction on the outdoor side surface 102 of the main body 100, it allows the communication holes to communicate with the ventilation holes 104 of the main body 100, or shields the ventilation holes.

The operating lever 810 penetrates through an outdoor cover 300 from the outer side of the outdoor cover 300 and is coupled with the ventilation hole-opening/closing plate 800. The operating lever 810 is moved by means of a user's operation in the longitudinal direction of the main body 100 to cause the ventilation hole-opening/closing plate 800 to be slid.

Next, the operation of the ventilation apparatus according to the second embodiment of the present invention will be described in greater detail.

First, if ventilation is required in a room, a user manipulates the operating lever 810 to cause the communication holes 800 of the ventilation hole-opening/closing plate 800 to communicate respectively with the ventilation holes 104 of the main body 100. With this arrangement, air communication can be made between the room and the outside, and outdoor air sequentially passes through slits 301 of the outdoor cover 300, the communication holes 801 of the ventilation hole-opening/closing plate 800, the ventilation holes 104 of the main body 100 and slits 201 of an indoor cover 200 so as to ventilate the room.

If ventilation is not required in the room, the user manipulates the operating lever 810 such that the communication holes 801 of the ventilation hole-opening/closing plate 800 can be offset from the ventilation holes 104 of the main body 100. With this arrangement, air communication cannot be made between the room and the outside, and thus, indoor air is prevented from being exhausted to the outside and outdoor air is prevented from being introduced into the room.

As described above, the ventilation apparatus for a sliding window according to the present invention has the following effects.

First, since the main body, the indoor cover, the outdoor cover and the finishing caps of the ventilation apparatus according to the present invention are made of plastic materials as a whole, the temperature of the ventilation apparatus is maintained to be constant and the temperature of a room is prevented from being raised (or lowered) even though temperature at the outside is high (or low). Moreover, even though there is a great difference in temperature between the outside and the room, it is possible to beforehand prevent the occurrence of a dew condensation phenomenon on the ventilation apparatus.

Second, in the ventilation apparatus according to the present invention, the glass pane-fixing rim can be smoothly attached to and detached from the main body, and thus, there is no need for separation of the window from a sash when the ventilation apparatus is mounted or demounted. Consequently, a process of installing the ventilation apparatus can be conveniently performed.

Third, in the ventilation apparatus according to the present invention, a coupling region between the glass pane-fixing rim and a glass pane is finished with silicone, resulting in improved airtightness and watertightness.

1. A ventilation apparatus for a sliding window, comprising:
a main body installed on at least one end of a window including a window frame and a glass pane, the main body having a plurality of ventilation holes formed therein;
an indoor cover detachably coupled to an indoor side surface of the main body;
an outdoor cover detachably coupled to an outdoor side surface of the main body;
a glass pane-fixing rim detachably coupled to a lower end of the indoor or outdoor side surface of the main body so as to fix the glass pane; and
finishing caps fitted into both side ends of the main body.

2. The ventilation apparatus as claimed in claim 1, further comprising an air filter provided between the main body and the indoor cover to filter out contaminants contained in outdoor air introduced into a room through the ventilation holes.

3. The ventilation apparatus as claims in claim 2, wherein the air filter is detachably coupled to the indoor cover.

4. The ventilation apparatus as claimed in claim 2, wherein the air filter is an antibiotic filter.

5. The ventilation apparatus as claimed in claim 1, wherein the main body has guide grooves formed at upper and lower ends of the outdoor side surface along a longitudinal direction thereof,
a ventilation hole-opening/closing plate for selectively opening or closing the ventilation holes of the main body is installed in the guide grooves such that the ventilation holes-opening/closing plate can be moved in a lateral direction, and
the outdoor cover has an operating lever provided on an outer side thereof such that the operating lever passes through the outdoor cover and is coupled to the ventilation hole-opening/closing plate so as to be operated in the longitudinal direction of the main body.

6. The ventilation apparatus as claimed in claim 1, wherein a gasket is interposed between the glass pane and the glass pane-fixing rim to maintain airtightness and watertightness.

7. The ventilation apparatus as claimed in claim 1, wherein the glass pane-fixing rim on the side of the window frame and a glass pane-fixing rim on the side of the main body are in face-to-face contact with each other at an acute angle.

8. The ventilation apparatus as claimed in claim 7, wherein the acute angle is 45°.

9. The ventilation apparatus as claimed in claim 1, wherein the glass pane-fixing rim on the side of the window frame and a glass pane-fixing rim on the side of the main body are in face-to-face contact with each other at a right angle.

10. The ventilation apparatus as claimed in claim 1, wherein the main body, the outdoor cover, the indoor cover and the finishing caps are made of plastic materials.

11. The ventilation apparatus as claimed in claim 2, wherein the main body has guide grooves formed at upper and lower ends of the outdoor side surface along a longitudinal direction thereof,
a ventilation hole-opening/closing plate for selectively opening or closing the ventilation holes of the main body is installed in the guide grooves such that the ventilation holes-opening/closing plate can be moved in a lateral direction, and
the outdoor cover has an operating lever provided on an outer side thereof such that the operating lever passes through the outdoor cover and is coupled to the ventilation hole-opening/closing plate so as to be operated in the longitudinal direction of the main body.
